(19) United States
(12) Patent Application Publication
(10) Pub. No.: US 2007/0110236 A1
(43) Pub. Date: May 17, 2007

(54) Encryption/recording device and method

(75) Inventor: Kenichiro Tada, Saitama (JP)

Correspondence Address: FOLEY AND LARDNER LLP;SUITE 500, 3000 K STREET NW, WASHINGTON, DC, 20007, US

(73) Assignee: PIONEER CORPORATION, Saitama (JP)

(21) Appl. No.: 10/577,805

(22) PCT Filed: Oct. 29, 2004
(86) PCT No.: PCT/JP04/16149

§ 371 Date: Apr. 28, 2006

(51) Int. Cl. H04N 7/167

(52) U.S. Cl. 380/201

(57) ABSTRACT

An encryption processing unit encrypts encoded data while changing an encryption key for at least one encryption block, and generates management information including key application information and application range information. A recording unit records the encrypted encoded-data and the management information on a recording medium. The encryption processing unit encrypts, when encryption key change timing is in a middle of encryption of the intraframe encoded image, at least one intraframe encoded image with a single encryption key to prevent the encryption key from being changed in the middle of the encryption of the one intraframe encoded image.

### TECHNICAL FIELD

The present invention relates to an encryption recording apparatus and an encryption recording method for encrypting and recording encoded data like an MPEG stream.

### BACKGROUND ART

In recent years, according to the progress of the multimedia technology, a technology for efficiently recording and reproducing digital video data has been developed. In recording digital video data or the like, from the viewpoint of protection of copyright, it is often desired to record the data after applying predetermined encryption to the data. The encryption is desired to make it difficult to decrypt data to secure security of data. For example, as a type of encryption that makes it difficult to decrypt data, there is a method of dividing one piece of content into a plurality of areas and encrypting the content by changing encryption keys for each of the areas. On the other hand, in reproducing encrypted digital video data or the like, to smoothly reproduce the data, it is desired to efficiently decrypt the data to perform smooth screen display.

A digital signal recording apparatus described in a Patent Document 1 encrypts, in recording a digital signal, the digital signal with a key obtained by applying a predetermined arithmetic operation to key information and records encrypted data on a recording medium together with the key information. In reproducing the digital signal, the digital signal recording apparatus decrypts the encrypted data reproduced from the recording medium with a key obtained by applying a predetermined arithmetic operation to the key information reproduced from the recording medium and outputs the data. This makes it impossible to obtain the key unless the predetermined arithmetic operation is applied to the key information even if the key information on the recording medium is obtained. The Patent Document 1 also discloses improvement of security of data through a change of encryption keys at fixed intervals.

Patent Document 1: International Application Publication No. 00/52690 Pamphlet.

### DISCLOSURE OF INVENTION

### Problem to be Solved by the Invention

However, according to the conventional technology, the digital signal is encrypted while the encryption keys are changed at fixed intervals. Therefore, in some cases, the encryption keys are changed when one I picture in a Group of Picture (GOP) is encrypted. In such a case, one I picture is encrypted by a plurality of encryption keys. Thus, in reproducing the digital signal, a plurality of decryption keys is required for one I picture. When one I picture is decrypted by the decryption keys, for example, in performing special play like fast-forward play and search, it is impossible to perform smooth video display because processing for changing the decryption key intervenes. This problem is an example of problems that the present invention is to solve.

The present invention has been devised in view of the problem and it is an object of the present invention to obtain an encryption recording apparatus and an encryption recording method that can perform, in performing special play such as fast-forward play and search, smooth video display without intervention of processing for changing a decryption key.

### MEANS FOR SOLVING PROBLEM

To solve the above problems and to achieve the object, an encryption recording apparatus according to one aspect of the present invention includes an input unit to which the encoded data formed by an encoding block including at least an intraframe encoded image is input; an encryption processing unit that encrypts the encoded data in predetermined encryption blocks while changing an encryption key for at least one encryption block; and a recording unit that records the encrypted encoded-data on a recording medium. The encryption processing unit encrypts at least one intraframe encoded image with a single encryption key to prevent the encryption key from being changed in a middle of encryption of the one intraframe encoded image.

An encryption recording method according to another aspect of the present invention is for encrypting and recording encoded data formed by an encoding block including at least an intraframe encoded image in predetermined encryption blocks while changing an encryption key. The encryption recording method includes encrypting at least one intraframe encoded image with a single encryption key to prevent the encryption key from being changed in a middle of encryption of the one intraframe encoded image.

### BRIEF DESCRIPTION OF DRAWINGS

FIG. 1 is a block diagram for explaining a constitution of an encryption recording apparatus according to a first example;

FIG. 2 is a diagram of information stored in a storing unit;

FIG. 3 is a diagram of information recorded on a recording medium;

FIG. 4 is a diagram for explaining a relation between CBCs and pictures;

FIG. 5 is a flowchart of a processing procedure from encryption to recording in the encryption and recording apparatus according to the first example;

FIG. 6 is a block diagram for explaining a constitution of an encryption recording apparatus according to a second example;

FIG. 7 is a diagram for explaining a relation between CBCs and GOPs; and

FIG. 8 is a flowchart of a procedure for inserting a NULL packet.

### EXPLANATIONS OF LETTERS OR NUMERALS

10 Encryption recording apparatus
15 Encryption recording apparatus
20 Information supplying unit
21 Key-change disable flag
30 Encrypting unit
31 CBC counter
32 Key generating unit
40 Recording unit
50 Recording medium
60 CPU
62 Storing unit
70 Encryption-key supplying unit
80 Encryption-key generating unit
100 Encryption processing unit

### BEST MODE(S) FOR CARRYING OUT THE INVENTION

Exemplary embodiments of a method and an encryption recording apparatus according to the present invention are explained in detail below with reference to the accompanying drawings. The present invention is not limited by the embodiments. In the following explanations, a schematic constitution and characteristics of the encryption recording apparatus of the present invention are explained as the embodiment and, then, examples concerning the encryption recording apparatus are explained.

### Embodiment

In this embodiment, content to be subjected to encryption processing is encoded data like a Motion Picture Expert Group-Transport Stream (MPEG-TS). The content includes an intraframe encoded image encoded only by information in an own frame like an I picture in the MPEG and other encoded images. For example, any one of an intraframe forward predicted encoded image predicted and created from a picture temporally located in the past like a P picture in the MPEG and an intraframe bidirectional predicted encoded image predicted and created from pictures temporally before and after the image like B pictures or both are assumed as the other images. In the MPEG, a Group of Picture (GOP) serving as an encode unit is formed by a combination of the I picture, the P picture, and the B picture. There are various modes for the GOP. At least one I picture is always present for one GOP.

On the other hand, a system for encrypting data at every predetermined data length (64, 128, or 256 bytes) like a Data Encryption Standard (DES), a 3DES, or an Advanced Encryption Standard (AES) is adopted. Moreover, a Cipher Block Chaining (CBC) is adopted from the viewpoint of protection of a plain text. Encryption keys are changed in one to a plurality of CBC block units. In other words, in this embodiment, encryption processing for encrypting encoded data such as the MPEG-TS in every predetermined encryption unit and changing the encryption keys in every one to a plurality of encryption units is performed.

When such encoded data is encrypted in every predetermined encryption unit and recorded on a recording medium, there is no correlation between a meaningful section in the encoded data and length of the encryption unit. The meaningful section in the encoded data indicates a break of the pictures or GOPs in the case of the MPEG.

Therefore, in a method of changing encryption keys in every fixed period, the encryption keys may be changed when one intraframe encoded image (I picture in the MPEG) is encrypted. In other words, one intraframe encoded image is encrypted by a plurality of encryption keys. In reproducing this encrypted part, a plurality of decryption keys are required. In fast-forward play, search, and the like, only the intraframe encoded image (I picture) is extracted and reproduced. However, when processing for changing a decryption key intervenes during the reproduction of one intraframe encoded image, it is impossible to perform smooth video display.

Thus, in this embodiment, an encoded image including at least one intraframe encoded image is encrypted using an identical encryption key.

For example, when encryption key change timing, which is timing for changing encryption keys in encrypting encoded data, is in the middle of encryption of the intraframe encoded image, the intraframe encoded image is encrypted using an identical encryption key by delaying the encryption key change timing to prevent the encryption key change timing from being in the middle of encryption of the intraframe encoded image. When the encryption key change timing is in the middle of encryption of the encode unit including the intraframe encoded image, the encoded image including at least one intraframe encoded image is encrypted using a single encryption key by inserting meaningless information like a NULL packet or random data to prevent the encryption key change timing from being in the middle of encryption of the encode unit.

As described above, in this embodiment, timing for changing encryption keys is prevented from being in the middle of the intraframe encoded image. Thus, it is possible to encrypt at least one intraframe encoded image with the identical encryption key. This makes it possible to decrypt at least one intraframe encoded image with an identical decryption key. Therefore, it is possible to perform smooth video display at the time of fast-forward play and search.

### FIRST EXAMPLE

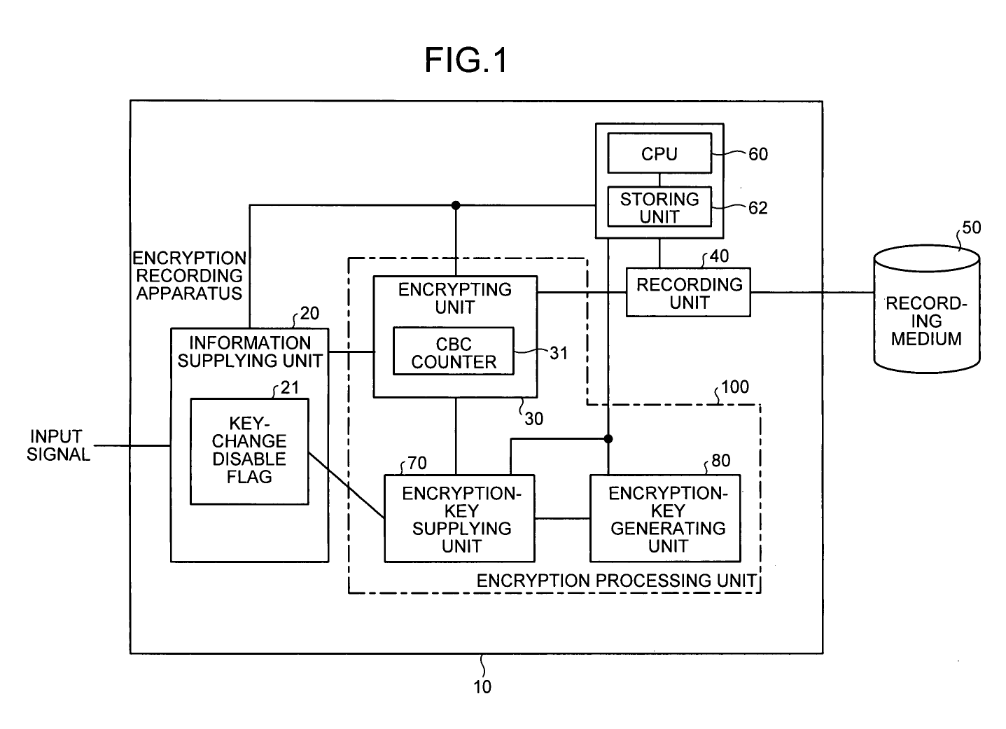

FIG. 1 is a diagram for explaining a constitution of an encryption recording apparatus according to a first example of the present invention. An encryption recording apparatus 10 applied to an Intelligent Video Digital Recorder (iVDR) and the like encrypts encoded data such as MPEG-TS on a real time basis and records the encoded data. The encryption recording apparatus 10 includes an information supplying unit 20, an encryption processing unit 100, a recording unit 40, a central processing unit (CPU) 60 serving as a control unit, and a storing unit (RAM) 62. The encryption processing unit 100 includes an encrypting unit 30, an encryption-key supplying unit 70, and an encryption-key generating unit 80. The encryption recording apparatus 10 is connected to a recording medium 50.

The information supplying unit 20 is an input unit to which encoded data is inputted from the outside. The information supplying unit 20 is connected to the encrypting unit 30, the encryption-key supplying unit 70, and the CPU 60. The start and the stop of operations of the information supplying unit 20 are controlled by a control signal from the CPU 60. The information supplying unit 20 supplies a partial Transport Stream (TS) signal inputted from the outside to the encrypting unit 30 at predetermined timing while buffering the partial TS signal for every size of data encrypted by the encrypting unit 30. The partial TS signal is a signal obtained by extracting information necessary for recording and reproduction from an MPEG-TS signal.

The information supplying unit 20 includes a data identifying unit (not shown) that determines, based on the partial TS signal inputted, whether a key change should be prohibited. The data identifying unit changes, according to a result of the determination, a state of a key-change disable flag serving as an identification flag for determining whether a change of encryption keys should be prohibited. The key-change disable flag is set to “1” when the key change is prohibited. The key-change disable flag is set to “0” when the key change is permitted.

Video data encoded in the MPEG is packetized in a predetermined size like 188 bytes or 192 bytes. In the encoding in the MPEG, an information compression ratio is different according to video data and the like. The video data is formed by an I picture, a B picture, a P picture, and the like having undefined lengths.

As described above, the I picture is an intraframe encoded image encoded only by information in an own frame. The I picture does not use correlation information of other screens temporally before and after the I picture. The I picture is arranged in video data at a fixed period. The P picture is an intraframe forward predicted encoded image predicted and created from the I picture and the P picture in the past. The B picture is an intraframe bidirectional predicted encoded image predicted and created from the I picture and the P picture temporally before and after the B picture.

A Group of Picture (GOP) is formed by a combination of the I picture, the P picture, and the B picture. There are various modes for the GOP. For example, one GOP is formed by fifteen pictures (frames) IBBPBBPBBPBBPBB or one GOP is formed by eighteen pictures (frames) IBBPBBPBBPBBPBBPBB. At least one I picture is always present in one GOP.

To determine whether a picture to be decrypted by the decrypting unit 30 is the I picture, the information supplying unit 20 detects the I picture in the inputted partial TS signal. The information supplying unit 20 sets the key-change disable flag to “1” during a period in which the I picture is detected. The information supplying unit 20 sets the key-change disable flag to “0” during a period in which the I picture is not detected. For example, the information supplying unit 20 sets, as a detection period for the I picture, a period from a point in time when the head of the I picture, a Sequence Header Code (SHC) similar to the head, a GOP header, or the like is detected until a point in time when the head of the B picture or the P picture is detected. The information supplying unit 20 sets the key-change disable flag to “1” in the detection period for the I picture. The information supplying unit 20 sets the key-change disable flag to “0” in periods other than the detection period for the I picture. It is possible to refer to this key-change disable flag with the encryption-key supplying unit 70.

When the encryption-key generating unit 80 receives a key generation notice signal from the CPU 60, the encryption-key generating unit 80 generates a new encryption key and sends the encryption key generated to the encryption-key supplying unit 70. The key generation notice signal sent from the CPU 60 to the encryption-key generating unit 80 indicates encryption key change timing. The key generation notice signal is generated, for example, at fixed time intervals or for every fixed number of CBC blocks by setting transmission time intervals of the key generation notice signal with a timer, a counter, or the like. In other words, the encryption-key generating unit 80 sequentially generates different encryption keys in response to the key generation notice signal and sends the encryption keys generated to the encryption-key supplying unit 70.

The encryption-key supplying unit 70 holds the encryption keys inputted from the encryption-key generating unit 80 and outputs the encryption keys held to the encrypting unit 30 and the storing unit 62 at timing determined according to a state of the key-change disable flag. In other words, when the key-change disable flag is “0”, the encryption-key supplying unit 70 immediately outputs the encryption keys inputted from the encryption-key generating unit 80 to the encrypting unit 30. When the key-change disable flag is “1”, even if the encryption keys are inputted from the encryption-key generating unit 80, the encryption-key supplying unit 70 does not output the encryption keys to the encrypting unit 30 at this point in time and holds the encryption keys. At a point in time corresponding to a first boundary position between encryption blocks after a point in time when the key-change disable flag changes from “1” to “0”, the encryption-key supplying unit 70 outputs the encryption keys to the encrypting unit 30. In this case, the encryption-key supplying unit 70 adjusts key change timing in the encryption in the encrypting unit 30.

The encrypting unit 30 includes a cipher-block-chaining (CBC) counter 31 that counts the number of encrypted blocks (CBC blocks) serving as encryption units. The encrypting unit 30 is connected to the information supplying unit 20, the encryption-key supplying unit 70, the recording unit 40, and the CPU 60. The encrypting unit 30 encrypts, for every encryption block with a fixed length, a partial TS signal inputted from the information supplying unit 20 using the encryption keys inputted from the encryption-key supplying unit 70. The encrypting unit 30 outputs the partial TS signal encrypted (hereinafter, “encrypted data”) to the recording unit 40. The CBC counter 31 counts the number of CBC blocks encrypted. The CBC counter 31 outputs a result of the count to the storing unit 62 via the CPU 60. As described above, the CBC is a cipher block chaining system for adding an immediately preceding cipher text to a plain text at the present point and encrypting a result of the addition with the Data Encryption Standard (DES), the 3DES, the Advanced Encryption Standard (AES), or the like.

The recording unit 40 records the encrypted data obtained from the encrypting unit 30 and management information of the encrypted data (temporarily stored in the storing unit 62) obtained from the CPU 60 on the recording medium 50. The recording medium 50 is a recording medium like a hard disk or an optical recording medium including a DVD. The encrypted data sent from the recording unit 40 and the management information of the encrypted data are recorded on the recording medium 50.

The CPU 60 collectively controls the respective components (the information supplying unit 20, the encrypting unit 30, the recording unit 40, the encryption-key supplying unit 70, and the encryption-key generating unit 80) of the encryption recording apparatus 10. The CPU 60 temporarily stores the management information of the encrypted data encrypted by the encrypting unit 30 in the storing unit 62. Further, the CPU 60 outputs a key generation notice signal serving as the encryption key change timing signal to the encryption-key generating unit 80, for example, at fixed time intervals corresponding to a predetermined number of CBC blocks.

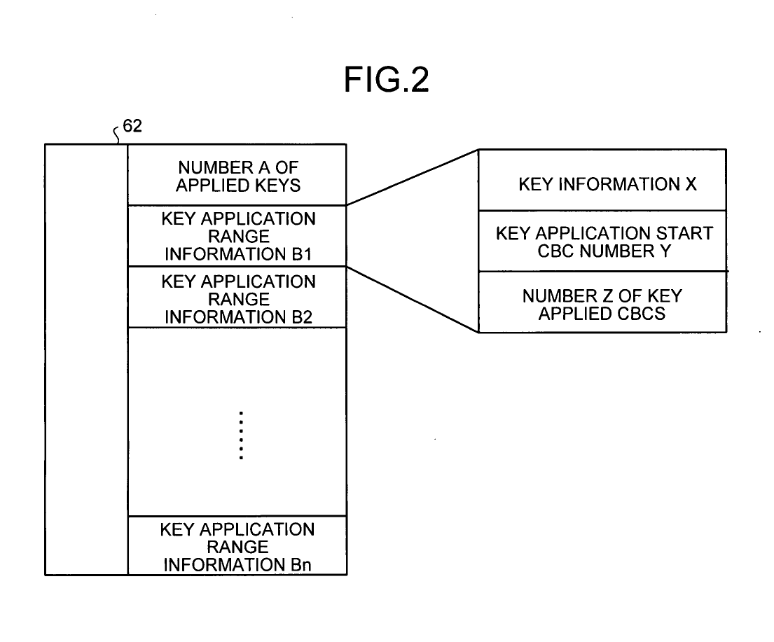

The management information stored in the storing unit 62 is explained. FIG. 2 is a diagram of a specific example of the management information stored in the storing unit 62. The management information includes the number of applied keys A and key application range information B1 to Bn (n is a natural number). The number of applied keys A indicates the number of keys n used in the encryption in the encrypting unit 30, that is, the number of pieces of key application range information B1 to Bn. The key application range information B1 to Bn includes key information X, a key application start CBC number Y, and the number of key applied CBCs Z. The key information X is information indicating the encryption keys used in the encryption in the encrypting unit 30, that is, the encryption keys generated by the encryption-key generating unit 80. The encryption keys are used as decryption keys when decryption is performed.

The key application start CBC number Y is a number of a CBC block from which application of a key X is started. For example, when the key X is applied from a tenth CBC block, the application start CBC number Y is 10. The number of key applied CBCs Z indicates the number of CBCs to which the key X is applied. For example, when the key X is applied from the tenth CBC block to a fifteenth CBC block, the number of key applied CBCs Z is 6.

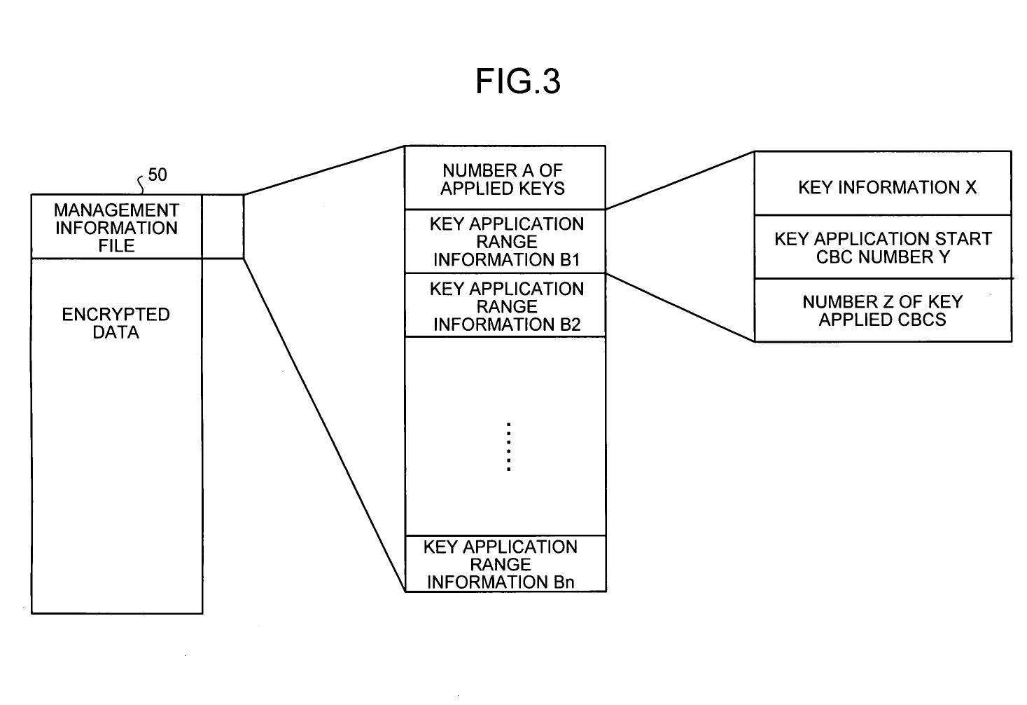

Information recorded on the recording medium 50 is explained. FIG. 3 is a diagram of the information recorded on the recording medium 50. The information written on the recording medium 50 includes the management information file and the encrypted data.

The management information file includes information for managing the encrypted data recorded on the recording medium 50. Like the management information temporarily stored in the storing unit 62, the management information file includes the number of applied keys A and the key application range information B1 to Bn. The respective pieces of key application range information B1 to Bn include the key information X, the key application start CBC number Y, and the number of key applied CBCs Z. The encrypted data recorded on the recording medium 50 is information such as the partial TS encrypted by the encrypting unit 30.

A method of delaying the encryption key change timing according to the key generation notice signal sent from the CPU 60 is explained. In the first example, to smoothly perform fast-forward play and the like performed by extracting the I picture or the like, one I picture is encrypted by an identical encryption key to prevent one I picture from being decrypted by different decryption keys.

In recording an MPEG-TS or the like while receiving the same, since real time processing is performed, it is difficult to recognize length of data of each I picture. It is also difficult to predict, when a NULL packet or the like is inserted between pictures, how original data of the MPEG-TS is affected. Therefore, in the first example, timing for performing key change is delayed with reference to a state of the key-change disable flag to prevent one I picture from being decrypted by different decryption keys.

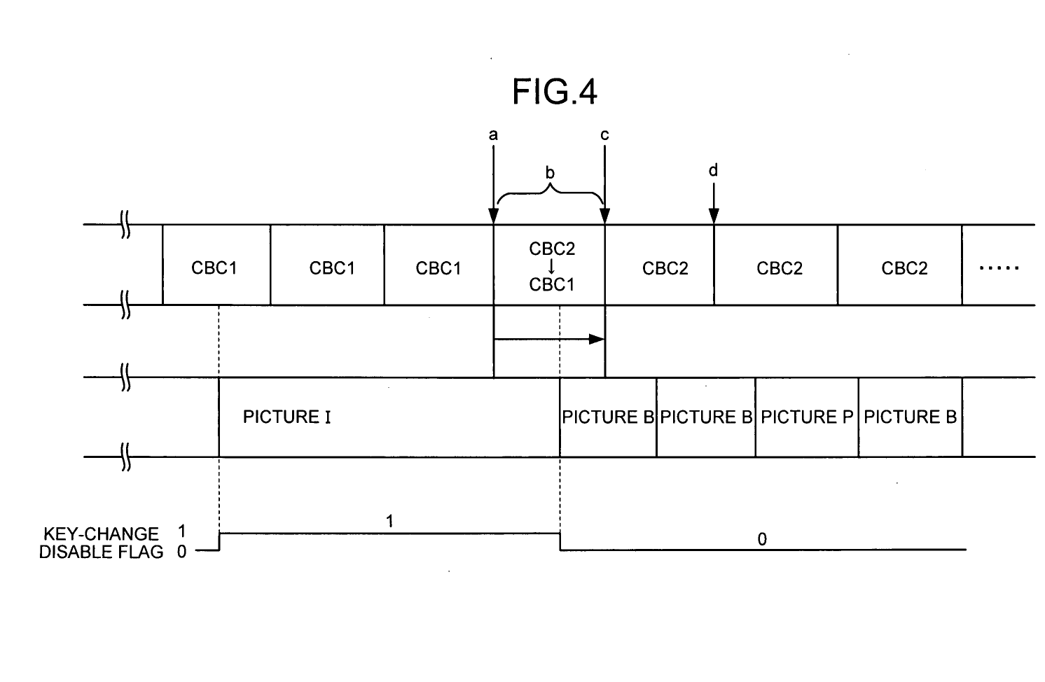

FIG. 4 is a diagram for explaining a relation between CBC blocks and pictures. In FIG. 4, it is assumed that CBC blocks to be encrypted have a fixed length and at the initial stage, for example, key change timing is set to change encryption keys for every three CBC blocks according to the key generation notice signal sent from the CPU 60. It is assumed that, at the initial stage, in FIG. 4, first three CBC blocks 1 (CBCs 1) are set to be encrypted by an identical first encryption key, the next three CBC blocks 2 (CBCs 2) are set to be encrypted by a second encryption key different from the first encryption key, and a point in time “a” is key change timing at the initial stage. In other words, it is assumed that, at the encryption key change timing at the initial stage by the key generation notice signal, a new second encryption key is inputted to the encrypting unit 30 from the encryption-key supplying unit 70 at the point in time “a” and, at the initial stage, a CBC block located in a section “b” is a CBC2 block encrypted by the second encryption key.

In this case, the initial key change timing “a” set according to the key generation notice signal sent from the CPU 60 is in the middle of the I picture. Therefore, the I picture is encrypted by two kinds of encryption keys. Thus, in the first example, the key change timing is delayed to prevent one I picture from being encrypted using different encryption keys. The key change timing is delayed by one CBC block serving as an encryption unit to set new key change timing as a point in time “c”.

Since the key-change disable flag is 1 at the point in time “a” that is the key change timing at the initial stage, the encryption-key supplying unit 70 does not input the new second encryption key to the encrypting unit 30 at this point in time “a”. The encryption-key supplying unit 70 inputs the new second encryption key to the encrypting unit 30 at the boundary point in time “c” of a first CBC block after the key-change disable flag is set to “0”. Therefore, key change is not performed in the encrypting unit 30 at the point in time “a” and an encryption block in the section “b” changes to an encryption block CBC 1 that is encrypted using the first encryption key. Three blocks after the point in time “c” are encryption blocks CBC2 that are encrypted using the second encryption key.

In this way, one I picture is encrypted only by the key for encryption of the CBCs 1. When one I picture is encrypted by one encryption key, it is possible to decrypt one I picture with one decryption key. In the case of FIG. 4, it is possible to encrypt one I picture using the identical encryption key simply by changing one CBC2 to the CBC 1. However, depending on length of the I picture, two to a plurality of CBCs 2 and CBC 3 may be changed to the CBCs 1.

In the case of FIG. 4, regardless of the fact that one CBC2 is changed to the CBC 1, the number of CBC blocks (CBCs 2) encrypted by the second encryption key remains three as set at the initial stage. However, the number of CBC blocks (CBCs 2) encrypted by the second encryption key may be reduced by the number of CBC blocks (in this case, one) changed from the CBC2 to the CBC 1. In that case, the number of CBC blocks (CBCs 2) in FIG. 4 changes to two.

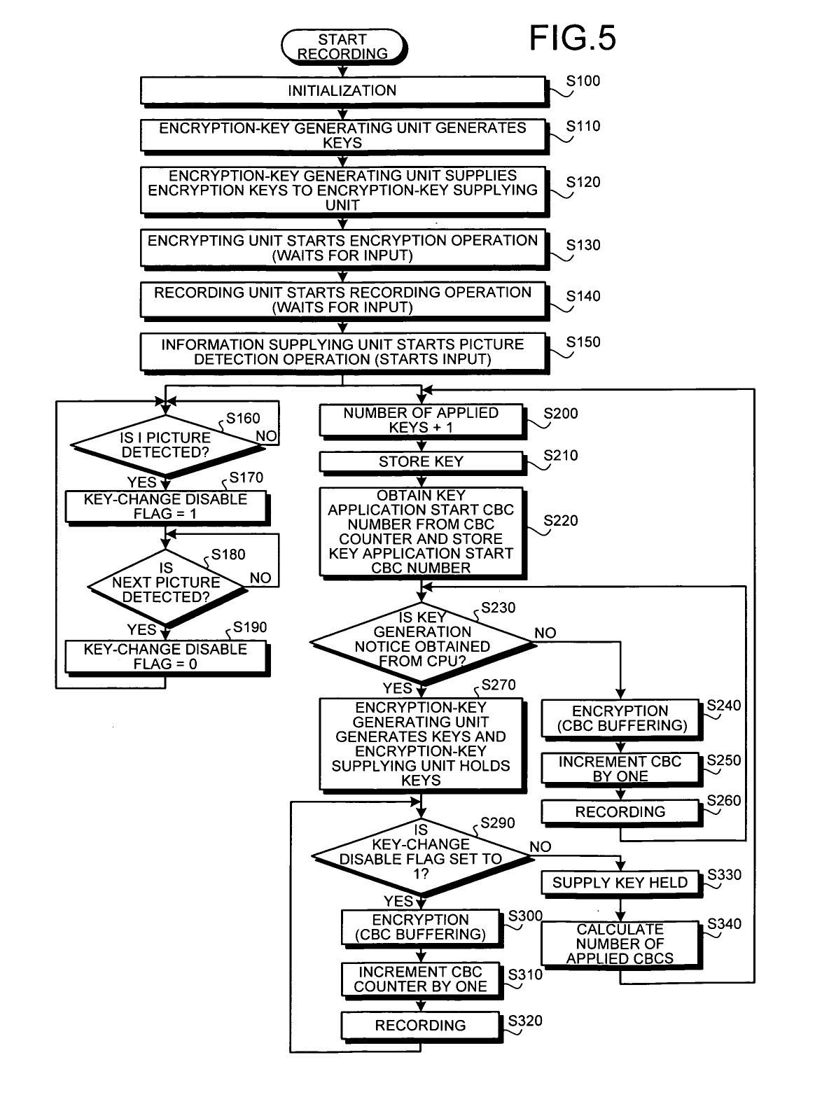

Operations of the respective components shown in FIG. 1 are explained in detail with reference to a flowchart in FIG. 5. In FIG. 5, a hardware flow of the respective components shown in FIG. 1 is represented as a software flowchart.

When a recording operation is started, initialization processing for clearing the storing unit 62, the CBC counter 31, and a key-change disable flag 21 is performed (step S100).

The encryption-key generating unit 80 generates a first encryption key and supplies the encryption key generated to the encryption-key supplying unit 70 (steps S110 and S120). When recording is started, the encryption-key supplying unit 70 immediately outputs the encryption key supplied from the encryption-key generating unit 80 to the encrypting unit 30 unconditionally, that is, without referring to the key-change disable flag. Moreover, the encryption-key supplying unit 70 outputs the encryption key supplied from the encryption-key generating unit 80 to the CPU 60.

The encrypting unit 30 comes into a data input waiting state in which encryption processing using the encryption key supplied from the encryption-key generating unit 80 is put on standby until data is inputted (step S130). The recording unit 40 also comes into a data input waiting state in which recording processing is put on standby until data to be recorded is inputted (step S140).

When a partial TS signal is inputted, the information supplying unit 20 starts an operation for detecting a picture in the partial TS signal inputted (step S150).

In other words, when the partial TS signal is inputted, the information supplying unit 20 supplies the partial TS to the encrypting unit 30 while buffering the partial TS signal for every predetermined data size. To determine whether a picture to be encrypted by the encrypting unit 30 is the I picture, the information supplying unit 20 detects the head of the I picture in the inputted partial TS signal (step S160). The information supplying unit 20 detects the head of the I picture by detecting the head of the I picture or a Sequence Header Code (SHC), a GOP header, or the like similar to the head of the I picture.

When the information supplying unit 20 detects the head of the I picture, the information supplying unit 20 raises the key-change disable flag from “0” to “1”. The key-change disable flag is held at “1” until a head of a B picture or P picture is detected. When a head of a B picture or P picture is detected (step S180), the key-change disable flag is dropped to “0” (step S190). In this way, during a period in which the I picture is detected, the key-change disable flag is held at “1” and, during a period in which the I picture is not detected, the key-change disable flag is set to “0”. The information supplying unit 20 repeatedly executes such processing at steps S160 to S190.

On the other hand, when the partial TS signal is inputted to the information supplying unit 20, the information supplying unit 20 informs the CPU 60 to that effect. Consequently, the CPU 60 increments a value of the number of applied keys A by 1 and stores a result obtained by incrementing the value of the number of applied keys A (in this case, the number of applied keys A=1) in a storage area for the number of applied keys A of the storing unit 62 (step S200).

Moreover, the CPU 60 stores the first encryption key supplied from the encryption-key supplying unit 70 at the point in time of step S120 in a storage area for the key information X of the storing unit 62 (step S210). The CPU 60 acquires a count output of the CBC counter 31 of the encrypting unit 30 and stores a count result acquired (in this case, an initial value of the CBC counter 31) in a storage area for the key application start CBC number Y of the storing unit 62 (step S220).

Until the encryption-key generating unit 80 receives the key generation notice signal from the CPU 60 (“No” at step S230), the encrypting unit 30 performs encryption processing in CBC block units using the first encryption key inputted from the information supplying unit 20 at step S110 from a point in time when the partial TS signal is inputted from the information supplying unit 20. In other words, the encrypting unit 30 sequentially encrypts partial TS signals, which are inputted from the information supplying unit 20 in CBC block units, in CBC block units using the first encryption key and sequentially outputs the partial TS signals encrypted, that is, encrypted data to the recording unit 40 while buffering the encrypted data in CBC block units (step S240). When one CBC block is encrypted, the CBC counter 31 increments a count value of the CBC counter 31 by one and outputs the count value to the CPU 60 (step S250). The recording unit 40 sequentially records the encrypted data inputted from the encrypting unit 30 in a required area of the recording medium 50 (step S260). The encryption processing using the first encryption key in the encrypting unit 30, the increment of the CBC counter 31, and the recording operation in the recording unit 40 described above are repeated until the key generation notice signal from the CPU 60 is inputted to the encryption-key generating unit 80.

Thereafter, when the key generation notice signal from the CPU 60 is inputted to the encryption-key generating unit 80 (“Yes” at step S230), the encryption-key generating unit 80 generates a second encryption key and outputs the second encryption key generated to the encryption-key supplying unit 70. The encryption-key supplying unit 70 holds the second encryption key inputted and refers to a state of the key-change disable flag 21 of the information supplying unit 20 (step S290). In this case, it is assumed that the key-change disable flag 21 of the information supplying unit 20 is “0”.

Since the key-change disable flag is “0” (“No” at step S290), the encryption-key supplying unit 70 immediately outputs the held encryption key inputted from the encryption-key generating unit 80 to the encrypting unit 30 and the CPU 60 (step S330). The CPU 60 performs an arithmetic operation for subtracting the value of the key application start CBC number Y acquired at step S220 from the count value of the CBC counter 31 at this point in time and stores a result of the arithmetic operation in the storing unit 62 as the number of key applied CBCs Z (step S340). In this case, at step S340, the number of key applied CBCs Z in the encryption processing by the first encryption key performed by repeating steps S230 to S260 is calculated.

The CPU 60 increments a value of the number of applied keys A by one and stores a result of incrementing the number of applied keys A by one (in this case, the number of applied keys A=2) in the storage area for the number of applied keys A of the storing unit 62 (step S200).

Moreover, the CPU 60 stores the second encryption key supplied from the encryption-key supplying unit 70 at the point in time of step S330 in the storage area for the key information X of the storing unit 62 (step S210). The CPU 60 acquires a count output of the CBC counter 31 of the encrypting unit 30 at this point in time and stores a count result acquired in the storage area for the key application start CBC number Y of the storing unit 62 (step S220).

Until the encryption-key generating unit 80 receives a new key generation notice signal from the CPU 60 (“No” at step S230), the encrypting unit 30 performs encryption processing by a unit of CBC block using the second encryption key inputted from the information supplying unit 20 at step S330. In other words, the encrypting unit 30 sequentially encrypts partial TS signals, which are inputted from the information supplying unit 20 in CBC block units, in CBC block units using the second encryption key and sequentially outputs encrypted data to the recording unit 40 while buffering the encrypted data in CBC block units (step S240). When one CBC block is encrypted, the CBC counter 31 increments a count value of the CBC counter 31 by one and outputs the counter value to the CPU 60 (step S250). The recording unit 40 sequentially records the encrypted data inputted from the encrypting unit 30 in a required area of the recording medium 50 (step S260). The encryption processing using the second encryption key in the encrypting unit 30, the increment of the CBC counter 31, the recording operation in the recording unit 40 are repeated until a new key generation notice signal from the CPU 60 is inputted to the encryption-key generating unit 80.

Thereafter, when the key generation notice signal from the CPU 60 is inputted to the encryption-key generating unit 80 (“Yes” at step S230), the encryption-key generating unit 80 generates a third encryption key and outputs the third encryption key generated to the encryption-key supplying unit 70. The encryption-key supplying unit 70 holds the third encryption key inputted and refers to a state of the key-change disable flag 21 of the information supplying unit 20 (step S290).

In this case, it is assumed that the key-change disable flag 21 of the information supplying unit 20 is “1”. Since the key-change disable flag is “1” (“Yes” at step S230), the encryption-key supplying unit 70 does not output the third encryption key inputted from the encryption-key generating unit 80 to the encrypting unit 30 at this point in time. The encryption-key supplying unit 70 holds the third encryption key and outputs the third encryption key to the encrypting unit 30 at a point in time corresponding to a first boundary position between encryption blocks (the point in time “c” in FIG. 4) after a point in time when the key-change disable flag changes from “1” to “0” (step S330).

In this case, if the encryption-key supplying unit 70 immediately inputs the encryption key supplied from the encryption-key generating unit 80 to the encrypting unit 30, the encrypting unit 30 performs timing adjustment for the respective units to change the encryption key at a boundary of CBC blocks. Therefore, the encryption-key supplying unit 70 only has to detect a boundary position between encryption blocks by sequentially detecting, using the timer counter or the like, points in time when time corresponding to one to a plurality of CBC blocks elapses (the points in time “c”, “d”, etc. in FIG. 4) after a point in time when the encryption key is inputted from the encryption-key generating unit 80 (e.g., the point in time “a” in FIG. 4) and output the third encryption key to the encrypting unit 30 at a point in time when a point in time corresponding to a first boundary position between encryption blocks is detected after a point in time when the key-change disable flag changes from “1” to “0”.

As described above, when the key-change disable flag is “1”, the encryption-key supplying unit 70 holds an encryption key (in this case, the third encryption key) inputted from the encryption-key generating unit 80 and outputs the encryption key to the encrypting unit 30 at a point in time corresponding to the first boundary position between encryption blocks (the point in time “c” in FIG. 4) after a point in time when the key-change disable flag changes from “1” to “0”. In this way, the encryption-key supplying unit 70 delays timing for supplying a new encryption key (in this case, the third encryption key) to the encrypting unit 30.

Therefore, the encryption-key generating unit 80 performs encryption with the second encryption key in a period from a point in time when the new encryption key (the third key in this case) is outputted from the encryption-key generating unit 80 until a point in time when the encryption key (the third encryption key in this case) is supplied to the encrypting unit 30 from the encryption-key supplying unit 70, that is, in the time of delay by the encryption-key supplying unit 70.

In other words, in this delay time, the encrypting unit 30 sequentially encrypts partial TS signals, which are inputted from the information supplying unit 20 in CBC block units, in CBC block units using the second encryption key and sequentially outputs encrypted data to the recording unit 40 while buffering the encrypted data in CBC block units (step S300). When one CBC bock is encrypted, the CBC counter 1 increments a count value of the CBC counter 31 by one and outputs the count value to the CPU 60 (step S310). The recording unit 40 sequentially records the encrypted data inputted from the encrypting unit 30 in a required area of the recording medium 50 (step S320).

The encryption processing using the second encryption key in the encrypting unit 30, the increment processing of the CBC counter 31, and the recording operation in the recording unit 40 are repeated until the key-change disable flag changes from “1” to “0”. Precisely, the encryption processing using the second encryption key added by the change of the key change timing is executed until a new third key is supplied to the encrypting unit 30 from the information supplying unit 20 after the key-change disable flag changes from “1” to “0”.

In this case, as described above, the encryption-key supplying unit 70 outputs the third encryption key to the encrypting unit 30 and the CPU 60 at a point in time corresponding to the first boundary position between encryption blocks (the point in time “c” in FIG. 4) after the point in time when the key-change disable flag changes from “1” to “0” (step S330).

The CPU 60 performs an arithmetic operation for subtracting the value of the key application start CBC number Y acquired at step S220 from a count value of the CBC counter 31 at this point in time and stores a result of the arithmetic operation in the storing unit 62 as the number of key applied CBCs Z (step S340). In this case, at step S340, the number of key applied CBCs Z in the encryption processing by the second encryption key, which is performed by repeating the processing at steps S230 to S260 and executing the processing at steps S300 to S320, is calculated.

The CPU 60 increments a value of the number of applied keys A by one and stores a result of incrementing the value of the number of applied keys A (in this case, the number of applied keys A=3) in the storage area for the number of applied keys A of the storing unit 62 (step S200).

Moreover, the CPU 60 stores the third encryption key supplied from the encryption-key supplying unit 70 at the point in time of step S330 in the storage area for the key information X of the storing unit 62 (step S210). The CPU 60 acquires a count output of the CBC counter 31 of the encrypting unit 30 at this point in time and stores a count result acquired in the storage area for the key application start CBC number Y of the storing unit 62 (step S220).

As described above, the encryption processing using the third encryption key in the encrypting unit 30, the increment of the CBC counter 31, and the recording operation in the recording unit 40 are executed by repeating the processing at steps S230 to S260.

Thereafter, when the key generation notice signal from the CPU 60 is inputted to the encryption-key generating unit 80 (“Yes” at step S230), the encryption-key generating unit 80 generates a fourth encryption key and outputs the fourth encryption key generated to the encryption-key supplying unit 70. Operations after this are the same as those described above. According to a state of the key-change disable flag 21 of the information supplying unit 20, it is decided whether key change timing should be changed. Encryption processing corresponding to a result of this decision is executed.

In this way, according to the first example, when change timing for an encryption key occurs in the middle of one I picture, change timing for an encryption key is delayed to encrypt one I picture with the identical encryption key. Thus, it is possible to perform smooth video display at the time of fast-forward play and search in a real time encryption recording apparatus that encrypts and records encoded video data such as an MPEG-TS on a recording medium while receiving the encoded video data.

In the first embodiment, the encryption-key supplying unit 70 adjusts the key change timing in encryption in the encrypting unit 30. However, the encrypting unit 30 may adjust the key change timing. For example, a buffer for holding new and old two encryption keys is provided in the encrypting unit 30. The encryption-key supplying unit 70 inputs an identification signal indicating which of the new and old two encryption keys is used to the encrypting unit 30 according to state identification of the key-change disable flag 21. At every break of CBC blocks, the encrypting unit 30 selects an encryption key to be used from the new and old two encryption keys with reference to an identification signal and performs encryption using the encryption key selected. In the first example, the CPU 60 instructs timing for changing encryption keys. However, encryption key change timing may be set in the encryption processing unit 100 itself in advance. The point is that, in encryption in the encrypting unit 30, encryption key change timing can only be delayed to prevent the encryption key change timing from being in the middle of the I picture. Any other method may be used as long as the method makes it possible to delay the encryption key change timing.

In the first example, one I picture is prevented from being encrypted by a plurality of encryption keys. However, an area prevented from being encrypted by a plurality of encryption keys is not limited to one I picture. For example, the area may be an area including one P picture or B picture in addition to one I picture. In the first example, the CBC is used as a system for encryption. However, the system for encryption is not limited to the CBC.

It is desirable to match a size of a CBC block with a physical access size of the recording medium 50 and match a start position of access to content with a start position of the CBC block. In other words, when a physical access unit is 512 bytes and the access can be logically made only by a unit of a multiple of 512 bytes, for example, 6144 bytes, the CBC block size is matched with this access unit. The access to content is performed from the head of a sector of a recording medium including a position of the access. Thus, if the access start position is matched with the start position of the CBC block, it is possible to access the CBC block simultaneously with the access to the sector. This makes it possible to simplify processing for decryption.

### SECOND EXAMPLE

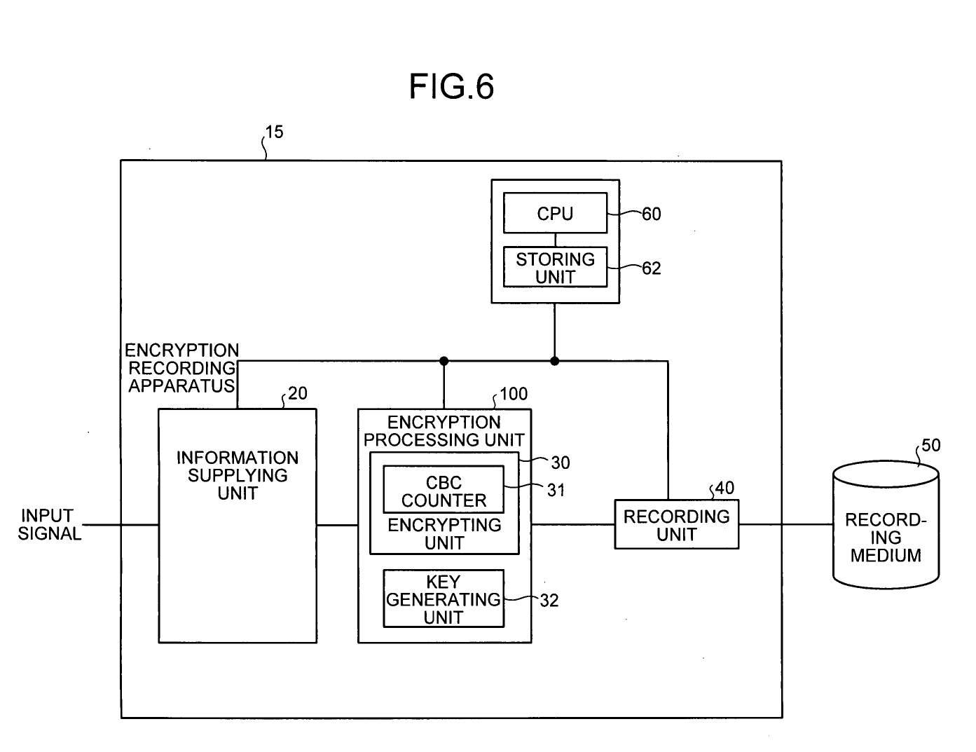

A second example is explained according to FIGS. 6 to 8. FIG. 6 is a block diagram for explaining a constitution of an encryption recording apparatus according to the second example of the present invention. Among components shown in FIG. 6, components that attain functions identical with those of the components in the first example shown in FIG. 1 are denoted by the identical reference numerals. In the second example, one GOP is encrypted by one encryption key to prevent one GOP from being decrypted by a plurality of decryption keys.

As described above, a Group of Picture (GOP) is formed by a combination of an I picture, a P picture, and a B picture. At least one I picture is always included in one GOP.

This encryption recording apparatus 15 has an authoring processing function and includes the information supplying unit 20, the encryption processing unit 100, the recording unit 40, the CPU 60, and the storing unit 62. The encryption processing unit 100 includes the encrypting unit 30 and a key generating unit 32. The encryption recording apparatus 15 is connected to the recording medium 50. Since authoring processing is non-real time processing, it is possible to learn, in advance, a size after encoding of a partial TS signal inputted and it is possible to freely determine a key change position.

Encoded video data such as a partial TS signal is inputted to the information supplying unit 20 from, for example, an external storage device. The partial TS signal is formed of a Sequence Header Code (SHC), a plurality of GOPs with an undefined data length, and the like. In other words, length of a data string including the GOPs changes depending on an encode system of the MPEG, the number of pixels, and the like. The start and the stop of operations of the information supplying unit 20 are controlled by a control signal from the CPU 60. The information supplying unit 20 supplies a partial Transport Stream (TS) signal inputted from the outside to the encrypting unit 30 at predetermined timing while buffering the partial TS signal for every size of data encrypted in the encrypting unit 30.

The information supplying unit 20 acquires information on a key change position (key change timing) in encryption processing performed by the encrypting unit 30 from the CPU 60 and detects a break position between adjacent GOPs in the partial TS signal inputted. The information supplying unit 20 determines whether the key change position and the break position between the GOPs coincide with each other. When the key change position and the break position do not coincide with each other, the information supplying unit 20 prevents encryption key change timing from being in the middle of encryption of a GOP (an encode unit) by executing processing for adding meaningless data, that is, a NULL packet, a private packet including random data, or the like to a position immediately before the GOP or the end of the GOP.

The encryption processing unit 100 includes the encrypting unit 30 including the CBC counter 31 that counts the number of encryption blocks (CBC blocks) serving as encryption units. The encryption processing unit 100 also includes the key generating unit 32 that sequentially generates different encryption keys at every fixed time interval or for every fixed number of CBC blocks according to a key generation notice signal from the CPU 60. The encrypting unit 30 encrypts the partial TS signal inputted from the information supplying unit 20 for every encryption block with a fixed length using the encryption keys generated by the key generating unit 32. The encrypting unit 30 outputs encrypted data to the recording unit 40.

The recording unit 40 records the encrypted data obtained from the encrypting unit 30 and management information of the encrypted data (temporarily stored in the storing unit 62) obtained from the CPU 60 on the recording medium 50. The recording medium 50 is a recording medium like a hard disk or an optical recording medium including a DVD. The encrypted data sent from the recording unit 40 and the management information of the encrypted data are recorded on the recording medium 50.

The CPU 60 collectively controls the respective components (the information supplying unit 20, the encrypting unit 30, and the recording unit 40) of the encryption recording apparatus 15. The CPU 60 temporarily stores the management information of the encrypted data encrypted by the encrypting unit 30 in the storing unit 62. Further, the CPU 60 outputs a key generation notice signal serving as the encryption key change timing signal to the encrypting unit 30, for example, at fixed time intervals corresponding to a predetermined number of CBC blocks.

As shown in FIG. 2, the key application range information B1 to Bn including the number of applied keys A, the key information X, the key application start CBC number Y, and the number of key applied CBCs Z is stored in the storing unit 62. As shown in FIG. 3, a management information file of the encrypted data recorded and the encrypted data encrypted by the encrypting unit 30 are recorded on the recording medium 50.

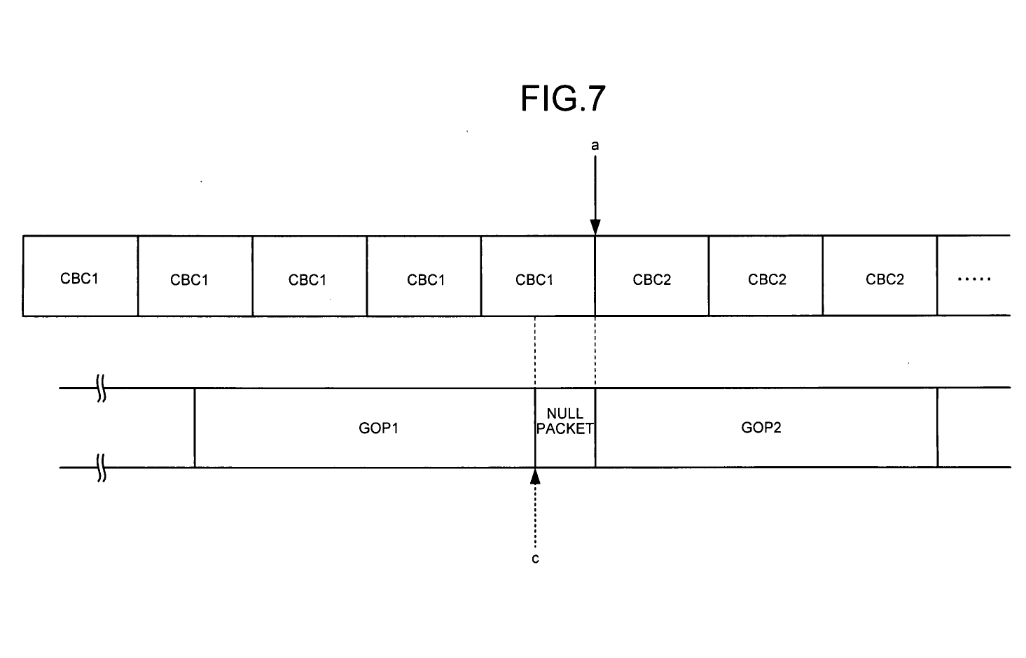

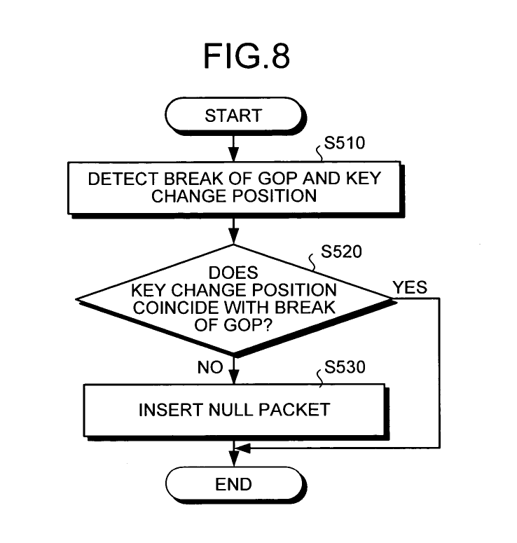

Processing for aligning key change timing and a break between GOPs (the head of a GOP) performed by the information supplying unit 20 is explained using FIGS. 7 and 8.

FIG. 7 is a diagram for explaining a relation between CBCs and GOPs. In FIG. 7, a CBC block to be encrypted has a fixed length. In FIG. 7, a first plurality of CBC blocks 1 (CBCs 1) are set to be encrypted by an identical first encryption key and the next plurality of CBC blocks 2 (CBCs 2) are set to be encrypted by a second encryption key different from the first encryption key. A point in time “a” is key change timing.

On the other hand, it is assumed that, in a partial TS signal at an initial stage inputted to the information supplying unit 20, a break of one GOP (GOP 1) and the next GOP (GOP2) is present at a point in time (a position) “c”. In this case, in the partial TS signal at the initial stage, the key change timing “a” is in the middle of the GOP2. The GOP2 is encrypted by a first encryption key and a second encryption key.

Thus, in the second example, the information supplying unit 20 performs processing shown in FIG. 8 such that one GOP is encrypted by one encryption key.

First, when an alignment request is inputted from the CPU 60, the information supplying unit 20 detects a break position between adjacent GOPs in an inputted partial TS signal and detects a key change position in encryption processing (step S510). It is possible to detect the break position between the GOPs using a GOP header or the like. Since a CBC block has a fixed length, it is possible to derive the key change position by obtaining information on a key change position (key change timing) such as a CBC block length (a fixed length) and the number of CBC blocks to be encrypted by an identical key from the CPU 60.

The information supplying unit 20 determines whether the break position between the GOPs acquired and the key change position coincide with each other (step S520). As a result of this determination, when the break position between the GOPs and the key change position do not coincide with each other, as shown in FIG. 7, the information supplying unit 20 inserts a NULL packet between the GOPs, in other words, immediately before the next GOP to make the key change position and the break position between the GOPs (a head position of the GOP) coincide with each other (step S530).

In the case of FIG. 7, a NULL packet having a data length that makes the key change position “a” and the break position between the GOPs coincide with each other is inserted between the GOP 1 and the GOP2. Consequently, the GOP2 is encrypted only by a key for encrypting the CBC2. In this way, when one GOP is encrypted by one encryption key, it is possible to decrypt one GOP with one decryption key.

As described above, according to the second embodiment, meaningless data such as a NULL packet is inserted to make a heat position of a GOP coincide with an encryption key change position. Thus, in an encryption recording apparatus having a function of subjecting encoded video data such as a received MPEG-TS to authoring processing, one GOP is encrypted by one encryption key. This makes it possible to perform smooth video display at the time of special play such as fast-forward play and search.

In the second example, the key change position and the break position between the GOPs (the head position of the GOP) are detected and the NULL packet is inserted between the GOPs to make the key change position and the break position coincide with each other. However, the following implementations are also possible.

First, the information supplying unit 20 detects data lengths of all GOPs in an inputted partial TS signal. The information supplying unit 20 determines whether the data lengths of the respective GOPs detected are integer times as large as a data length (a fixed length) of a CBC block. The information supplying unit 20 inserts a NULL packet at the end of a GOP, a data length of which is not integer times as large as the data length of the CBC block, to make the data length integer times as larger as the data length of the CBC block. In other words, in this case, to make a head of a GOP coincide with a break of CBC blocks, the information supplying unit 20 inserts the NULL packet at the end of a GOP immediately preceding the GOP. For at least one GOP, the information supplying unit 20 appropriately changes a key change position such that the GOP is encrypted by an identical key. Consequently, it is possible to always encrypt at least one GOP with one encryption key.

In the second example, the processing performed by the information supplying unit 20 may be performed by the encryption processing unit 100.

1-8. (canceled)

9. An encryption recording apparatus comprising:
an input unit to which encoded data formed by an encoding block including at least an intraframe encoded image is input;
an encryption processing unit that encrypts the encoded data while changing an encryption key for at least one encryption block, and generates management information including key application information indicating number of encryption keys used in encrypting the encoded data and application range information indicating an application range for each of the encryption keys; and
a recording unit that records the encrypted encoded-data and the management information on a recording medium, wherein
the encryption processing unit encrypts, when encryption key change timing is in a middle of encryption of the intraframe encoded image, at least one intraframe encoded image with a single encryption key to prevent the encryption key from being changed in the middle of the encryption of the one intraframe encoded image, and
the application range information includes key information indicating the encryption key, a key application start number indicating a start position of the encryption block where the key information is used, and number of the encryption keys used.

10. The encryption recording apparatus according to claim 9, wherein
the encryption key is used as a decryption key when decrypting the encrypted encoded-data.

11. The encryption recording apparatus according to claim 9, wherein
the encryption processing unit delays, when encryption key change timing is in the middle of the encryption of the intraframe encoded image, the encryption key change timing to prevent the encryption key from being changed in the middle of the encryption of the intraframe encoded image.

12. The encryption recording apparatus according to claim 11, wherein
the input unit includes a data identifying unit that detects the intraframe encoded image from the input encoded data, and changes a state of an identification flag based on detection of the intraframe encoded image, and
the encryption processing unit determines whether to delay the encryption key change timing, based on the state of the identification flag.

13. The encryption recording apparatus according to claim 12, wherein
the data identifying unit sets the identification flag in a state of disabling a change of the encryption key in a period from detection of a head of the intraframe encoded image to detection a head of an encoded image different from the intraframe encoded image.

14. The encryption recording apparatus according to claim 9, wherein
the input unit inserts, when the encryption key change timing is in a middle of encryption of the encoding block, dummy information right before the encoding block to prevent the encryption key from being changed in the middle of the encryption of the encoding block.

15. An encryption recording method comprising:
encryption processing including
encrypting encoded data formed by an encoding block including at least an intraframe encoded image while changing an encryption key for at least one encryption block; and
generating management information including key application information indicating number of encryption keys used in encrypting the encoded data and application range information indicating an application range for each of the encryption keys; and
recording the encrypted encoded-data and the management information on a recording medium, wherein
the encrypting includes encrypting, when encryption key change timing is in a middle of encryption of the intraframe encoded image, at least one intraframe encoded image with a single encryption key to prevent the encryption key from being changed in the middle of the encryption of the one intraframe encoded image, and
the application range information includes key information indicating the encryption key, a key application start number indicating a start position of the encryption block where the key information is used, and number of the encryption keys used.

16. The encryption recording method according to claim 15, wherein
the encrypting includes delaying, when encryption key change timing is in the middle of the encryption of the intraframe encoded image, the encryption key change timing to prevent the encryption key from being changed in the middle of the encryption of the intraframe encoded image.

17. The encryption recording method according to claim 15, further comprising:
inserting, when the encryption key change timing is in a middle of encryption of the encoding block, dummy information right before the encoding block to prevent the encryption key from being changed in the middle of the encryption of the encoding block.
